(19) United States
(12) Patent Application Publication
(10) Pub. No.: US 2018/0007861 A1
(43) Pub. Date: Jan. 11, 2018

(54) ANIMAL LITTER COMPOSITIONS

(71) Applicant: Confluence Energy, LLC, Kremmling, CO (US)

(72) Inventors: Mark Joseph Mathis, Silverthorne, CO (US); Jonah Levine, Lafayette, CO (US)

(73) Assignee: Confluence Energy, LLC, Kremmling, CO (US)

(21) Appl. No.: 15/641,902

(22) Filed: Jul. 5, 2017

Related U.S. Application Data
(60) Provisional application No. 62/358,446, filed on Jul. 5, 2016.

(51) Int. Cl. A01K 1/015

(52) U.S. Cl. CPC A01K 1/0155

(57) ABSTRACT

Provided herein are animal litter compositions comprising wood particles activated carbon, and a clumping agent. The wood particles have a moisture content between 4% and 25%. The composition does not comprise wood particles with a moisture content outside the range of between 4% and 25%. The composition has a density between about 30 lbs./ft³ and about 45 lbs./ft³ and is essentially dust free. These animal litter compositions may be made by contacting wood particles with activated carbon and a clumping agent to form a mixture. The mixture is extruded the mixture into a densified material having a density between about 30 lbs./ft³ and about 45 lbs./ft³. The size of the densified material is reduced to between about 0.5 mm about 2 mm (US Mesh 16-US Mesh 6).

### CROSS-REFERENCE TO RELATED APPLICATIONS

The present application claims priority under 35 U.S.C. §119(e) to provisional application No. 62/358,446 titled “Animal Litter Compositions,” filed on Jul. 5, 2016, which is incorporated herein by reference in its entirety for all purposes.

### TECHNICAL FIELD

Aspects of the present disclosure involve animal litter compositions and methods, and particularly animal litters comprising wood particles.

### BACKGROUND

Animal litters of various compositions are commonly used to control and remove animal waste. The most well-known litter compositions are sold by retailers for controlling cat waste and are widely used by cat owners.

Known animal litter compositions are fabricated primarily from one of four materials: clay; vegetable matter such as grass, hay or alfalfa; wood chips, shavings or sawdust; and paper, such as shredded, flaked or pelletized paper. For example, the high density of clay litters makes them heavy and awkward to carry in the larger quantities. In addition, clay is not readily biodegradable, and proper disposal is inconvenient. Clay litters are also especially prone to produce dust and tracking out by the animal. Grass, hay or alfalfa based litters are less dense than clay and are biodegradable, but are highly susceptible to bacterial and mold growth, and generally produce odors offensive to people and that seem offensive to animals. The wood-based litters are also lightweight, but are highly susceptible to tracking, lack absorbency, and rarely clump.

The foregoing examples of the related art and limitations related therewith are illustrative and not exclusive. Other limitations of the related art will become apparent to those of skill in the art upon reading the specification.

### SUMMARY

The following embodiments and aspects thereof are described and illustrated with compositions and methods meant to be exemplary and illustrative, not limiting in scope. In various embodiments, one or more of the above-described problems have been reduced or eliminated, while other embodiments are directed to other improvements.

Aspects of the present disclosure involve an animal litter composition comprising wood particles, activated carbon and/or biochar, and a clumping agent. The wood particles have a moisture content between 4% and 25%. The composition does not comprise wood particles with a moisture content outside the range of between 4% and 25%. The composition has a density between about 30 lbs./ft³ and about 45 lbs./ft³ and is essentially dust free. In particular, the clumping agent may be guar gum, which may be present at between about 2% and about 10% by weight of the total composition. Sometimes the composition may further comprise a surfactant.

The wood particles may have a moisture content of 4% to 15%, and wherein the composition does not comprise wood particles with a moisture content outside the range of 4% to 15%. In particular, the wood particles may have a moisture content of 5% to 10%, and wherein the composition does not comprise wood particles with a moisture content outside the range of 5% to 10%. The wood particles may be between about 0.250 mm and about 4 mm in size, such as between about 0.500 mm and about 2 mm in size. Generally, the animal litter compositions do not comprise clay-based material, silica, or an animal-edible ingredient.

Aspects of the present disclosure also involved a method for making an animal litter composition. Wood particles are contacted with activated carbon and/or biochar and a clumping agent to form a mixture, wherein the wood particles have a size between about 0.25 mm and about 4 mm and a moisture content between about 4% and about 15%. It important that the wood particles be of a relatively small size to promote absorption and clumping while the animal litter composition is in use. The mixture is extruded into a densified material having a density between about 30 lbs./ft³ and about 45 lbs./ft³, during which the size of the densified material is reduced to between about 0.5 mm about 2 mm (US Mesh No. 16 to US Mesh No. 6). The animal litter composition is essentially dust free.

The present disclosure provides animal litter compositions produced using any method for making an animal litter compositions described.

The present disclosure also provides methods for using an animal litter composition, comprising contacting any animal litter composition described and animal excreta.

### DETAILED DESCRIPTION

Provided herein is an animal litter composition, comprising wood particles, activated carbon or biobased carbon and a clumping agent. The wood particles may be of a uniform moisture content, size, and wood source. The composition may also comprise a mixture of wood particles of differing particular moisture contents, sizes, or wood sources. Also provided are methods for forming the animal litter compositions and methods for using the animal litter compositions.

### (I) Animal Litter Compositions

Provided herein is an animal litter composition, comprising wood particles, activated carbon and/or biochar, and a clumping agent. These compositions are especially useful for trapping animal excreta.

As used herein “excretum” (plural “excreta”) refers to waste matter discharged from the body of animal, including but not limited to feces, scat, urine, sweat, sputum, mucus, phlegm, and vomitus.

### (i) Wood Particles

The wood source may be from any tree or wood plant. The wood source may be a lodgepole pine, ponderosa pine, Scotch pine, whitebark pine, limber pine, Douglas-fir, blue spruce, Pinus contorta, beech, western scrub, north coast scrub, or a sand, shore or knotty pine.

The moisture content of the wood particle may be adjusted by considering the degree of drying of the wood source. A wood source that is not dry enough may be difficult to manufacture into a wood particle. As used herein, “moisture content” is calculated by the formula (A−B)/B×100%, where A is the mass of the wood particle and B is the oven-dry mass of the wood particle (e.g., after drying for 24 hours at 103+/−2° C.). The timber of living trees and freshly felled logs contains a large amount of water, which often constitutes over 50% of the woods' weight. The wood particle may have a moisture content of at least 4%, 5%, 6%, 7%, 8%, 9%, 10%, 11%, 12%, 13%, 14%, 15%, 16%, 17%, 18%, 19%, 20%, 21%, 22%, 23%, 24%, 25%, or any range thereof. Besides a minimum moisture content, or in lieu thereof, the wood particle may have a moisture content of less than 25%, 24%, 23%, 22%, 21%, 20%, 19%, 18%, 17%, 16%, 15%, 14%, 13%, 12%, 11%, 10%, 9%, 8%, 7%, 6%, 5%, 4%, or any range thereof. Therefore, the moisture content of the wood particle may be from about 4% to about 10%, from about 5% to about 15%, from about 5% to about 20%, or from about 5% to about 25%. The moisture content of the wood particle may not be lower than 4%, and is not higher than 15%.

The size of the wood particle may be adjusted considering the intended application. For example, wood particles too small may not effectively disperse in certain environments. Wood particles with desired maximum and/or minimum particle sizes may be obtained by using screens or other size separation technology known in the art. The wood particle may be relatively small, which may be a width smaller than between about No. 60 mesh (0.250 mm) about No. 30 mesh (0.595 mm). The wood particle may also be relatively large, which may be a width larger than between about No. 18 mesh (1.00 mm) and about No. 5 mesh (4.00 mm). The wood particle may also be of mid-size, which may be a width between about No. 25 mesh (0.707 mm) and about No. 20 mesh (0.841 mm). In some embodiments, the size of the wood particles may be defined by to bottom mesh size of about 30 (0.595 mm) and a top mesh size of 10 (2.00 mm). In other words, the wood particles may have a size between about 0.250 mm and about 4 mm, such as between about 0.25 mm and about 0.5 mm, between about 0.5 mm and about 0.75 mm, between about 0.75 mm and about 1 mm, between about 1 mm and about 1.25 mm, between about 1.25 mm and about 1.5 mm, between about 1.5 mm and about 1.75 mm, between about 1.75 mm and about 2 mm, between about 2 mm and about 2.25 mm, between about 2.25 mm and about 2.5 mm, between about 2.5 mm and about 2.75 mm, between about 2.75 mm and about 3 mm, between about 3 mm and about 3.25 mm, between about 3.25 mm and about 3.5 mm, between about 3.5 mm and about 3.75 mm, and between about 3.75 mm and about 4 mm.

The composition may not include a wood particle with a moisture content other than at least 4%, 5%, 6%, 7%, 8%, 9%, 10%, 11%, 12%, 13%, 14%, 15%, 16%, 17%, 18%, 19%, 20%, 21%, 22%, 23%, 24%, 25%, or any range thereof. The composition may also not include a wood particle with a moisture content of other than less than 25%, 24%, 23%, 22%, 21%, 20%, 19%, 18%, 17%, 16%, 15%, 14%, 13%, 12%, 11%, 10%, 9%, 8%, 7%, 6%, 5%, 4%, or any range thereof. Therefore, the moisture content of any wood particle in the composition may not be outside the range of from about 4% to about 10%, from about 5% to about 15%, from about 5% to about 20%, or from about 5% to about 25%. The moisture content of any wood particle in the composition may not be lower than 4%, and may not be higher than 15%.

Substantially all of the wood particles in the composition may have a moisture content of at least 4%, 5%, 6%, 7%, 8%, 9%, 10%, 11%, 12%, 13%, 14%, 15%, 16%, 17%, 18%, 19%, 20%, 21%, 22%, 23%, 24%, 25%, or any range thereof. Besides a minimum moisture content, or in lieu thereof, substantially all of the wood particles in the composition may have a moisture content of less than 25%, 24%, 23%, 22%, 21%, 20%, 19%, 18%, 17%, 16%, 15%, 14%, 13%, 12%, 11%, 10%, 9%, 8%, 7%, 6%, 5%, 4%, or any range thereof. Therefore, the moisture content of substantially all of the wood particles in the composition may be from about 4% to about 10%, from about 5% to about 15%, from about 5% to about 20%, or from about 5% to about 25%. The moisture content of substantially all of the wood particles in the composition may not be lower than 4%, and may not be higher than 15%.

The wood particles may have a density between about 30 lbs./ft³ to about 45 lbs./ft³, such as between about 35 lbs./ft³ and about 40 lbs./ft³.

### (ii) Activated Carbon

The animal litter compositions described herein may comprise a carbon source selected from activated carbon, biobased carbon, biocarbon, or biochar.

Activated carbon, also called activated charcoal, activated coal, or active carbon, is a form of elemental carbon processed to have small, low-volume pores that increase the surface area available for adsorption or chemical reactions, such as absorbing malodorous chemicals, such as animal excreta. Due to its high porosity on the microscopic and macroscopic scales, one gram of activated carbon has a surface area over at least 200 m², such as of at least 500 m² (5,400 sq. ft.), as determined by gas adsorption. An activation level sufficient for useful application may be attained solely from high surface area; however, further chemical treatment often enhances adsorption properties.

In various embodiments, the carbon source may be processed into the animal litter composition during pelletizing or extrusion. In particular, the activated carbon may be presented in the form of extruded activated carbon (EAC), which combines powdered activated carbon with a binder (such as the wood particles described herein). The activated carbon and the binder are fused together and extruded into a cylindrical shaped activated carbon block with diameters between about 0.8 mm and about 130 mm.

In one embodiment, the activated carbon may be in the form of bead activated carbon made from petroleum pitch and supplied in diameters between about 0.35 mm and about 0.80 mm. Similar to EAC, bead activated carbon low pressure drop, high mechanical strength and low dust content, but with a smaller grain size.

### (iii) Clumping Agent

The animal litter compositions disclosed herein may comprise a clumping agent, which allows the animal litter composition to more easily clump after being exposed to animal excreta. Suitable examples clumping agents include starches (such as corn starch, potato starch, and the like), pregelatinized and modified starches thereof, sweeteners, microcrystalline cellulose, alginates, sodium starch glycolate, and gums (such as agar, guar, locust bean, karaya, pecitin, and tragacanth). In particular, the clumping agent may be a gum, such as agar gum, guar gum, locust bean gum, karaya gum, pecitin, or tragacanth. In exemplary embodiments, the clumping agent may be guar gum. Alternatively, the clumping agent may be derived from the protective coating (psyllium) of seeds from the genus of Plantago plants (plantains, fleaworts). A particularly useful species is Plantago ovata. Although clays (such as bentonite) are common clumping agents, they are not suitable for us in the present animal litter compositions or methods.

The clumping agent may be used in the range of about 2% to about 40% by weight of the total composition. For example, the animal litter may comprise between about 2% and about 3% of clumping agent, between about 3% and about 4% of clumping agent, between about 3% and about 4% of clumping agent, between about 4% and about 5% of clumping agent, between about 5% and about 6% of clumping agent, between about 6% and about 7% of clumping agent, between about 7% and about 8% of clumping agent, between about 9% and about 10% of clumping agent, between about 9% and about 10% of clumping agent, between about 10% and about 15% of clumping agent, between about 15% and about 20% of clumping agent, between about 20% and about 25% of clumping agent, between about 25% and about 30% of clumping agent, between about 30% and about 35% of clumping agent, or between about 35% and about 40% of clumping agent by weight of the total composition. The animal litter composition may comprise less than about 40 vol. % clumping agent. The animal litter composition may comprise less than about 10 vol. % clumping agent. The animal litter composition may comprise more than about 2 vol. % clumping agent. The animal litter composition may comprise less than about 20 vol. % clumping agent.

In particular embodiments, the clumping agent is guar gum. When present, the guar gum may be used in the range of about 2% to about 10% by weight of the total composition. For example, the animal litter may comprise between about 2% and about 3% of guar gum, between about 3% and about 4% of guar gum, between about 3% and about 4% of guar gum, between about 4% and about 5% of guar gum, between about 5% and about 6% of guar gum, between about 6% and about 7% of guar gum, between about 7% and about 8% of guar gum, or between about 9% and about 10% of guar gum by weight of the total composition. The animal litter composition may comprise less than about 10 vol. % guar gum. The animal litter composition may comprise more than about 2 vol. % guar gum.

In some embodiments, the clumping agent may comprise a starch, such as potato starch or corn starch. When present, the starch may be used in the range of about 20% to about 40% by weight of the total compositions. For example, the animal litter may comprise between about 20% and about 25% of starch, between about 25% and about 30% of starch, between about 30% and about 35% of starch, or between about 35% and about 40% of starch. The animal litter composition may comprise less than about 40 vol. % starch. The animal litter composition may comprise more than about 20 vol. % starch.

### (iv) Optional Components

The animal litter composition may comprise one or more optional components, including, but not limited to, surfactant, fillers, binders (in addition to the wood particles themselves), disintegrants, dessicants, dyes, and deodorants. Some animal litter composition may further comprise switch grass. Generally, the animal litter compositions do not contain clay-based material, silica, or an animal-edible ingredient, such as a foodstuff or flavoring.

In various embodiments, the animal litter composition may comprise a surfactant. When surfactant was present, the animal litter compositions quickly absorbed the animal excreta, so fluids did not seep to the bottom of the litter box and did not cause the animal litter to stick to the bottom of the litter box. Suitable examples of surfactant include, but are not limited to a alkylaryl polyether alcohol, such as Triton™ X-100, Surfonic™ N-100 (nonoxaynol-10), or Witconol™ NP-100; or a poloxamer, such as Pluronic™, Synperonic™, or Kolliphor™. Other suitable examples of surfactants include, for example, 2-acrylamido-2-methylpropane sulfonic acid, alkyl polyglycoside, ammonium perfluorononanoate, benzalkonium chloride (BAC), benzethonium chloride (BZT), 5-bromo-5-nitro-1,3-dioxane, cetyl trimethylammonium bromide (CTAB, hexadecyltrimehtylammonium bromide, cetyl trimethylammonium chloride), cetylpridinium chloride (CPC), cyclohexyl-1-hexyl-maltopyranoside, decylmaltopyranoside, decyl polyglucose, dimethyldioctadecylammonium chloride, dioctadecyldimethylammmonium bromide (DODAB), dipalmitoylphosphatidylcholine, lauryldimethylamine oxide, dodecylmaltopyranoside, magnesium laureth sulfate polyethoxylated tallow amine (POEA), octenidine dihydrochloride, octylphenoxypolyethoxyethanol (Igepal™ CA-630), octylthioglucopyranoside (OTG), ox gall, sodium nonanoyloxybenzensulfonate, sorbitan monolaurate, surfactin, and thonozonium bromide.

The additional component may be an inorganic chemical that facilitates clumping, odor-control, or the like such as gypsum or other calcium salt, magnesium salt, or phosphorous salt.

### II. Methods of Making the Compositions

Also provided herein is a method for making an animal litter composition. Wood particles are contacted with activated carbon and a clumping agent to form a mixture. These wood particles, before mixing, have a size between about 0.25 mm and about 4 mm and a moisture content between about 4% and about 15%. The mixture is extruded into a densified material having a density between about 30 lbs./ft³ and about 45 lbs./ft³. The size of the densified material is then reduced to between about 0.5 mm about 2 mm. In the end, the animal litter composition is essentially dust free.

Starting with a wood source, the wood may be reduced in size to produce wood chips. As commonly understood, wood chips are small wood pieces of unspecified size that are ground, broken or cut from trees, logs, or larger wood pieces using equipment such as a disc chipper, drum chipper, grinder or crusher, or any other equipment known for making such product or by-product in the art. The size of wood chips sizes can vary depending on the techniques, equipment and production methods used. For example, the wood chip can have a width of sawdust to approximately 2 inches.

The wood chip may then be dehydrated, or subjected to wood drying or wood seasoning, to reduce the moisture content of the wood chip. The wood chip may be air-dried, mechanically died, friction dried, kiln-dried, or subjected to any other drying process known in the art. In the drying process, the temperature, relative humidity and air circulation may be controlled to achieve the desired amount of drying, which may be relatively uniform or consistent among individual wood chips in the same batch. Depending on the starting moisture content of the wood chip, the duration of the drying time may be adjusted accordingly. The common practice in wood dehydrating is to ensure drying timber at the fastest possible rate without causing objectionable defects such as wood collapse, distortions or discoloration.

The dehydrated wood chip may be densified, which may be performed prior to or after mixing with other components in the animal litter composition. The biomass of the wood chip may be joined by using various treatments, such as pressure and heat. In addition, the natural lignin, cellulose or hemicellulose in the wood may form a natural binder, so the joined and processed wood biomass forms many shapes and sizes for various uses.

The wood chip may also be densified by impregnating its void volume with a synthetic or natural polymer in liquid form and then solidifying by chemical reaction or by cooling of the impregnant. Alternatively, wood density can be increased by compression in the transverse direction. The processes suitable for densifying the woody biomass on a production scale can be classified into two types: pelletizing (pelleting) and extrusion briquetting, either of which may produce the wood particle. General types of equipment available for wood densification include a screw-type extruder, die type extruder and a compacting ram. Wood particles produced by extrusion can be in a form of chunk, crumble, lump, hunk or other irregular masses of varying widths depending upon equipment and die geometry.

The wood particles may be fractionated based on size. Surprisingly, the smaller the starting size of the wood particles, regardless of the size of the complete animal litter composition, provided better clumping properties to the animal litter. Without wishing to be bound by theory, the smaller particles provided a greater surface area for absorbing animal excreta, thereby promoting contact between the animal excreta and the other ingredients of the animal litter composition. For example, screens may select wood particles with a desired maximum and/or minimum particle size. This enhanced absorbency and clumping was preserved following densification and size reduction of the densified material. Suitable sizes for wood particles are described herein.

The wood particles are then combined with activated carbon and a clumping agent to provide an animal litter composition. In some embodiments, the mixture may further comprise a surfactant. The animal litter composition may be passed through one of more screens to select its particle size and to remove fine dust, so that in the end the finished animal litter composition is essentially dust free.

### EXAMPLES

### Example 1—EcoPett™ Characterization

EcoPett™ is an animal litter composition containing dehydrated densified sawdust (38 lb/ft³), activated carbon, guar gum, and a surfactant. The compositions is grey to black in color. Odor depends on the wood source and aging.

EcoPett™ was tested for odor reduction and odor control. A 10% aqueous solution of household ammonia was added to 250 g animal litter composition. Odor was measured after 10 minutes. The experiment was repeated in duplicate. After 10 minutes, the animal litter composition smelled only of pine. No ammonia was detected using ammonia test papers with a sensitivity of 1 ppm.

Clay specification was not provided. Odor was evaluated at 5 minutes, 10 minutes, 30 minutes, 1 hour, and 24 hours.

Absorption was measured by immersing 25 g animal litter composition in 1000 mL water for 3 minutes (N=4). EcoPett™ exhibited 4.68 times the weight-to-weight absorption, where 25 g animal litter composition solidified 117 g water.

Clumping was measured by placing 40 mL water on 250 g animal litter composition (N=2). A 100% clump formed with a regular-shaped mass basis.

Clump integrity was tested by placing 25 mL water onto 250 g animal litter composition. After forming, the clump dropped from 12 inches. The clump formed from EcoPett™ remained 90% intact after being dropped from this distance: 27 g intact from a 30 g starting mass.

### Example 3—Comparison Between Cat Litters

Three animal litters were tested in a side-by-side comparison:
(A) World's Best Clumping Formula cat litter,
(B) EcoPett™ cat litter (described above at Example 1), and
(C) BLUE Naturally Fresh® Multi-Cat Quick Clumping Formula cat litter.

World's Best Cat Litter™ brand litter is made from whole kernel corn and is available from GPC Pet Products, a division of Grain Processing Corp having offices in Muscatine, Iowa. Specifically, the cat litter comprises ground whole corns, spent corn germ, citrus residue, starch used as a cohesiveness agent, as described in U.S. Pat. No. 7,753,002. The cat litters are described as 99% dust-free.

EcoPett™ is as described above at Example 1.

BLUE Naturally Fresh® Multi-Cat Quick Clumping Formula cat litter is a proprietary blend of the fibrous materials found in walnut shells distributed by Blue Buffalo.

Clump test—About 5 mL water were squirted into a small well formed in a bed of cat litter. The results are:
A—The clump can be removed using a slotted scoop typically used with cat litter. When dropped onto a table from about 12 inches, the clump shatters into many pieces.
B—The clump can be removed using a slotted scoop. When dropped onto a table from about 12 inches, the clump bounces and does not break. When dropped from 4 feet, the clump remains intact.
C—The clump cannot be removed using a slotted scoop. When picked up from the scoop, the clump breaks. It shatters further when dropped onto a table from about 0.5 meters.

Absorption test—Roughly 4:1 (w/w) water/cat litter were mixed in a vessel and allowed to stand for about one minute. The results are:
A—Still had standing fluid. Poured out like wet cereal, presumably because it is made from corn, which is an animal-edible foodstuff.
B—No standing fluid. The total liquid has been solidified. The entire mixture of water and animal litter composition stayed in the vessel when the vessel was inverted.
C—Standing fluids. The majority of cat litter stayed in the vessel when inverted, but some dribbled out like wet cereal.

Thus, EcoPett™ was the best in class for both clumping and absorption.

### Example 3—Nature's Scoop™ Animal Litter Composition

Nature's Scoop™ consists of wood particles, activated carbon, and guar gum. Nature's Scoop™ is a high performance, quick clumping pine animal litter composition that outperforms other pine, corn, nut, and clay-based litters on the market. The quick clumping composition results in strong, easy-to-scoop clumps—almost instantly. The composition is super absorbent, with excellent, long-lasting odor control that traps odor causing urine, immediately neutralizing ammonia odors resulting in a naturally fresh pine scent.

Nature's Scoop™ absorbs about three times more moisture as traditional clay-based litters. The composition comprises activated carbon for added odor control and lasting protection. This composition is and environmentally friendly, 100% natural product recycled from Rocky Mountain pine trees. The composition is biodegradable product, meaning it is easier on the environment. Nature's Scoop™ also contains no artificial fragrances, toxins, chemicals or dyes. The animal litter composition is essentially dust free for easy breathing and a cleaner home, and eliminates the silica dust from clay-based litters. It is also low tracking; so homes stay cleaner.

Various modifications and additions can be made to the exemplary embodiments discussed without departing from the present disclosure. For example, while the embodiments described above refer to particular features, the scope of this disclosure also includes embodiments having different combinations of features and embodiments that do not include the described features. As another example, an embodiment may include features discussed referring to other embodiments. Processes and methodologies discussed herein may be set out in an order; however, the order set out is merely exemplary and operations may be conducted in different orders. Accordingly, the scope of the present disclosure is intended to embrace all such alternatives, modifications, and variations together with all equivalents thereof.

1. An animal litter composition comprising:
wood particles;
activated carbon; and
a clumping agent;
wherein the wood particles have a moisture content between 4% and 25%;
wherein the composition does not comprise wood particles with a moisture content that is outside the range of between 4% and 25%; and
wherein the composition has a density between about 30 lbs./ft³ and about 45 lbs./ft³ and is essentially dust free.

2. The composition of claim 1, wherein the clumping agent is guar gum or an extract from a Plantago plant.

3. The composition of claim 1, wherein the clumping agent is present at between about 2% and about 10% by weight of the total composition.

4. The composition of claim 1, further comprising a surfactant.

5. The composition of claim 1, wherein the wood particles have a moisture content of 4% to 15%; and wherein the composition does not comprise wood particles with a moisture content that is outside the range of 4% to 15%.

6. The composition of claim 5, wherein the wood particles have a moisture content of 5% to 10%; and wherein the composition does not comprise wood particles with a moisture content that is outside the range of 5% to 10%.

7. The composition of claim 1, wherein the wood particles are between about 0.25 mm and about 4 mm in size.

8. The composition of claim 7, wherein the wood particles are between about 0.5 mm and about 2 mm in size.

9. The composition of claim 1, which does not comprise clay-based material, silica, or an animal-edible ingredient.

10. A method for making an animal litter composition, comprising:
contacting wood particles with activated carbon and a clumping agent to form a mixture, wherein the wood particles have a size between about 0.25 mm and about 4 mm and a moisture content between about 4% and about 15%;
extruding the mixture into a densified material having a density between about 30 lbs./ft³ and about 45 lbs./ft³; and
reducing the size of the densified material to between about 0.5 mm about 2 mm;
wherein the animal litter composition is essentially dust free.

11. The method of claim 10, further comprising providing the wood particles with a size between about 0.25 mm and about 4 mm in size.

12. The method of claim 10, further comprising drying the wood particles to a moisture content between about 4% and about 15%.

13. The method of claim 10, wherein the clumping agent is guar gum or an extract from a Plantago plant.

14. The method of claim 10, wherein the clumping agent is present at between about 2% and about 10% by weight of the total composition.

15. The method of claim 10, wherein the mixture further comprises a surfactant.

16. An animal litter composition produced using a method of claim 10.

17. A method for using an animal litter composition, comprising contacting an animal litter composition of claim 1 and animal excreta.
